(19) United States
(12) Patent Application Publication
(10) Pub. No.: US 2019/0364126 A1
(43) Pub. Date: Nov. 28, 2019

(54) COMPUTER-IMPLEMENTED METHOD, COMPUTER PROGRAM PRODUCT, AND SYSTEM FOR IDENTIFYING AND ALTERING OBJECTIONABLE MEDIA CONTENT

(71) Applicant: Mark Todd, Centerville, UT (US)

(72) Inventor: Mark Todd, Centerville, UT (US)

(21) Appl. No.: 15/990,515

(22) Filed: May 25, 2018

(51) Int. Cl. H04L 29/08

(52) U.S. Cl. CPC H04L 67/2823; H04L 67/34; H04L 67/20

(57) ABSTRACT

A computer-implemented method, computer program product, and system for identifying and altering objectionable media content adapted to identify and alter objectionable data in both incoming and outgoing media content, as well as media content queued for storage in computer-readable memory. The method may be downloaded on a communication device that receives or sends out media content. A proxy, or third party scanning service, provides a recognition software that searches data in the media content to identifying objectionable images, text, video, audio, and voice data. Once the objectionable data is identified, the recognition software alters the identified objectionable data to cover, replace, or delete objectionable images, text, audio, and voice data. The objectionable portion of the data is partially determined by objectionable parameter filters and media transmission filters selected by a user. A non-objectionable portion of the data remains unaltered so that media content remains substantially in its original format. Thus, original media content is viewed with minimal compromise.

### BACKGROUND OF THE INVENTION

### Field of the Invention

This invention relates generally a computer-implemented method, computer program product, and system for identifying and altering objectionable media content, and more specifically relates to a method that searches media content to identify objectionable images, text, video, audio, and voice data, and then alters an objectionable portion of the data while maintaining a non-objectionable portion of the data, so as to minimize compromising the media content.

### Description of the Related Art

The popularity of the Internet has led to a rise in of the use of the Internet to transmit pornographic and obscene materials, while the increased availability and more powerful functions of smart phone has lead to increased opportunities to create amaterur pornographic content. This has been a particular problem for schools and families with children and teenagers having access to both the Internet and high-functioning smart phones. Unless strictly and constantly supervised, a child or adolescent with basic Internet skills can access materials that are inappropriate for their viewing.

It is known in the art that efficient and robust internet content filtering has long been a desirable and sought-after feature. This is true not only for controlling the content that a user is exposed to on the internet, but also for recording that activity and allowing restrictions to be overridden as needed. It is also recognized that content-control software is designed to restrict or control the content a reader is authorized to access, especially when utilized to restrict material delivered over the Internet via the Web, e-mail, or other means. Content-control software determines what content will be available or be blocked.

However, the internet contains myriad media content in the form of images, videos, text, and audio data, which is difficult to search and filter the objectionable data contained therein. Efficient means on not just blocking or truncating objectionable content, but of redacting it while queued for writing into computer readable content or queued/stacked for display or transmission to or from a browser, are unknown in the art. Most filters and content-control software delete the entire media content upon identifying objectionable material. The filtering of media content is generally not customizable to a user's filtering needs.

In view of the foregoing, it is clear that these traditional techniques are not perfect and leave room for more optimal approaches.

### SUMMARY OF THE INVENTION

From the foregoing discussion, it should be apparent that a need exists for a computer-implemented method, computer program product, and system for identifying and altering objectionable media content. Beneficially, such a method would identify and alter objectionable data in media content by searching the media content to identify objectionable images, text, audio, video, and voice data; and then altering an objectionable portion of the data while maintaining a non-objectionable portion of the data, so as to minimize compromising the media content.

The present invention has been developed in response to the problems and needs in the art that have not yet been fully solved by currently available apparati and methods. Accordingly, the present invention has been developed to provide an automated process to search for objectionable data in media content, and then alter the objectionable data, while maintaining the non-objectionable data in an unaltered state.

The computer-implemented method, computer program product, and system for identifying and altering objectionable media content comprises an initial Step of downloading the computer-implemented method on a communication device.

Another Step includes selecting at least one objectionable parameter filter and at least one media transmission filter.

The method may include a further Step of retrieving incoming and outgoing media content.

Another Step comprises transmitting the retrieved media content to a proxy, or third party scanning service.

An additional Step may include systematically searching the media content with at least one of the following: an object recognition software, a text recognition software, an audio recognition software, and a voice recognition software.

A Step comprises identifying, by the recognition software, an objectionable portion of the data, the objectionable portion of the data including at least one of the following: pornography, violent images, profane text, profane language, hate speech, propaganda.

Another Step includes whereby the objectionable portion of the data is at least partially determined by the selected objectionable parameter filter and the media transmission filter.

In some embodiments, a Step may include identifying, by the recognition software, a non-objectionable portion of the data.

A Step comprises altering the objectionable portion of image or video data by blurring or covering a portion of the image or video data with at least one visual barrier.

A Step comprises altering the objectionable portion of text data by replacing the objectionable text data with a synonym.

A Step comprises altering the objectionable portion of audio data by deleting or replacing the audio data.

A final Step includes returning the media content with the objectionable portion of the data altered and the non-objectionable portion of the data uncompromised.

One objective of the present invention is to systematically search media content for objectionable data, such as pornography, profane words, hate speech, and other socially unacceptable terms, and remove only the portion of the media content that is objectionable, while not altering the rest of the media content.

Another objective is to allow the user to filter the type of objectionable data to be filtered.

Another objective is to allow the user to filter the media transmission means for media content to be searched.

Another objective is to utilize object recognition software, a text recognition software, an audio recognition software, and a voice recognition software to search for, and alter the objectionable data.

Yet objective is to provide a visual barrier to block viewing of objectionable data from an image.

Yet objective is to replace profane words with synonyms.

Yet objective is to terminate operation of a web camera when objectionable video data is identified by the video recognition software.

Yet objective is to not affect the portion of the media content that is non-objectionable.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is flow chart referencing an exemplary method for identifying and altering objectionable media content;

FIG. 2 is an options box viewable on a communication device that enables selecting at least one objectionable parameter filter and at least one media transmission filter;

FIG. 3 is a media content depiction of a statue showing objectionable image data and non-objectionable image data;

FIG. 4 is a media content depiction of a statue, showing objectionable image data covered by a semi-opaque bar visual barrier;

FIG. 5 is a media content depiction of a statue, showing objectionable image data covered by a solid bar visual barrier;

FIG. 6 is a media content depiction of a statue, showing objectionable image data covered by an exaggerated visual barrier;

FIG. 7 is a depiction of a hand visual barrier, an emoji visual barrier, and a skull visual barrier for covering objectionable image data;

FIG. 8 is a depiction of an objectionable phrase replaced with an altered phrase to remove objectionable text data;

FIG. 9 is a text substitution table that contains a list of objectionable text, and corresponding non-objectionable text;

FIG. 10 is a user-proxy diagram illustrating the relationship between an exemplary user and proxy that exchange data and search queries through an exemplary web server; and

FIG. 11 is a typical computer system that serves as an exemplary method for identifying and altering objectionable media content.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are given to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The embodiments of the present invention described herein generally provide for a computer-implemented method, computer program product, and system for identifying and altering objectionable media content. The method is configured to identify and alter objectionable data in both incoming and outgoing media content. The method provides a variety of different recognition software that search data in the media content to identify objectionable data, such as image data, text data, audio data, video data, and voice data.

The parameters and transmission means of objectionable data to be identified is at least partially determined by a user selecting from at least one objectionable parameter filter and at least one media transmission filter. Once the objectionable data is identified, the recognition software alters the objectionable data to block, obfuscate, replace, or terminate viewing of objectionable images, text, audio, video, and voice data. Yet, the non-objectionable data remains unaltered so that the media content remains substantially in its original format. This allows the original media content to be viewed with minimal compromise.

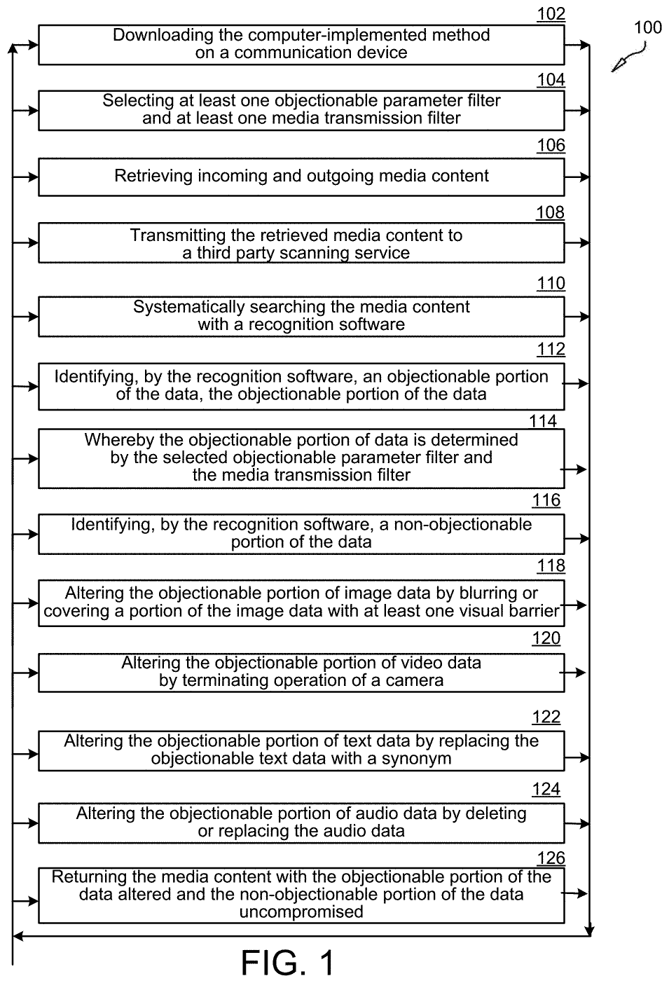

FIG. 1 illustrates a flowchart that references an exemplary method 100 for identifying and altering objectionable media content. The method 100 includes an initial Step 102 of downloading the computer-implemented method 100 on a communication device. The computer-implemented method 100 may include a software application “app”, or computer program that is configured to operate on a communication device, such as a phone, tablet, laptop, computer, or watch.

In some embodiments, the software application may be received from a remote system, including, without limitation, a web server, an FTP server, and email server. A user can download the software application directly onto the communication device to filter and alter the objectionable media content, as described below. Once downloaded, the method is operational on that communication device.

A Step 104 includes selecting at least one objectionable parameter filter and at least one media transmission filter. Once the software application is downloaded, the user has the option to select from at least one objectionable parameter filter 216. The objectionable parameter filter represents the format, or the type of data that is to be subsequently identified and possibly altered, if determined to be objectionable. The objectionable parameter filter may include, without limitation, images, video, language, and audio.

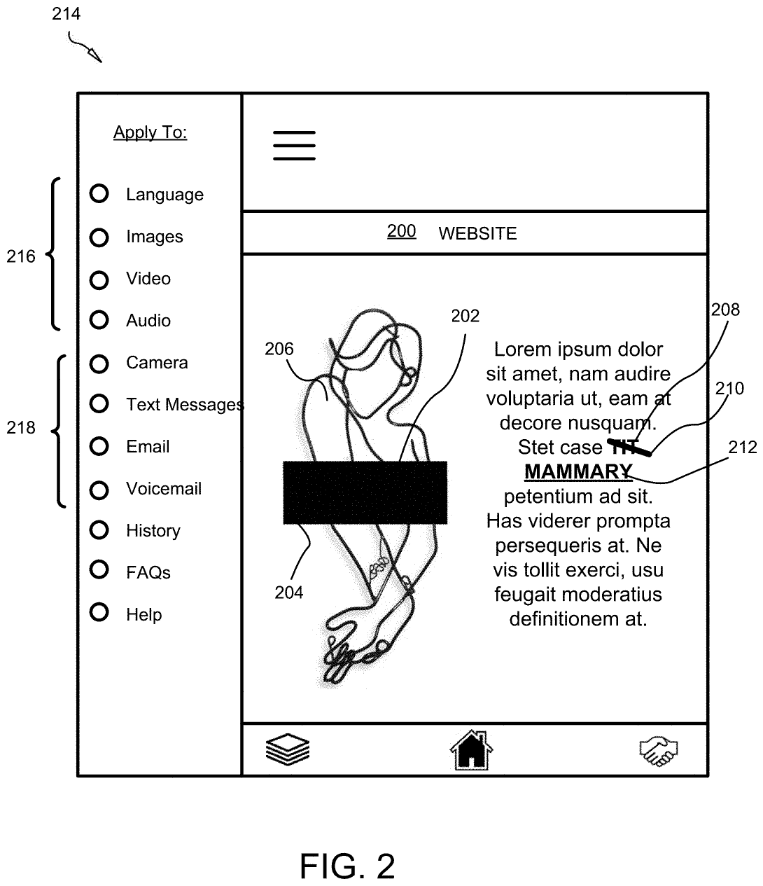

FIG. 2 references an options page 214, viewable from the communication device that is used to select at least one of the objectionable parameters. From the options page 214, the user can select the images objectionable parameter 216 in order to limit the identification and altering of image data, such as pictures of human anatomy, blood, anatomical postures, and the like. This may be effective for filtering pornographic or violent pictures.

Similarly, selecting the video objectionable parameter limits the identification and altering of data to only video data, such as webcam videos and pornographic scenes. This may be effective for filtering videos posted by a user, or an associate of a user, on a webcam; or filtering pornographic or violent scenes.

And selecting the language objectionable parameter limits the identification and altering of data to only language data, such as text, symbols, and characters. This may be effective for filtering emails, texts, and other written compositions that include profane language, threats, or hate speech.

And selecting the audio objectionable parameter limits the identification and altering of data to only audio data, such as the human voice. This may be effective for filtering profane language in a recorded audio message that includes profane language, threats, or hate speech.

The other filtering options that the user can select from the options box 214 include at least one media transmission filter 218. The media transmission filter 218 includes the eclectic types of digital transmission means known in the art through which the media content can be delivered. FIG. 2 references various selectable options that are available for selecting the media transmission filters 218, including, without limitation, email, hypertext transfer protocol (http), text message, voicemail, phone, a camera, and a web camera. The user selects the media transmission means for which the media content is to be searched for objectionable data.

For example, if a user wants to filter only pornographic websites media content 200 received on a laptop, the user would select “images”, “video”, and “http”. As shown in FIG. 2, upon receiving the media content 200, an image visual barrier 204 alters, by covering, the objectionable image of the breast 202. However, the non-objectionable image of the upper torso 206 remains uncovered, and available for viewing.

In another example, if a user wants to filter pornographic reading spam received by email on a laptop, the user may select “images”, “video”, “email”, “laptop”. In this instance, a text visual barrier 210 covers the objectionable word “tit” 208, and a synonym 212 “mammary gland” replaces “tit”.

In yet another example, if a user wants to filter violent depictions and hate speech on a cell phone, the user may select “images”, “video”, “audio”, phone” from the available options 214 of objectionable parameter filters 216 and the media transmission filters 218. In these examples, the original image data and text data are altered, without changing a substantial portion of the media content 200.

In various embodiments of the present invention, images are filtered which comprise pixels falling within a predetermined shade range, or within a predetermined range of colors. If the amount of pixels falling within this range exceeds a predetermined threshold (for instance more than 20% of the pixels in the image), the image is filtered. This threshold may vary between 5% and 75%. If the number of pixels contrasting with one another in any particular image exceeds a predetermined threshold, the image may also be filtered.

In other embodiments, images are filtered comprises two or more sets of pixels falling within two or more predetermined ranges of colors or shades (e.g., images having two or more sets of pixels satisfying two predetermined color range thresholds are filtered).

The method 100 may include a further Step 106 of retrieving incoming and outgoing media content. The media content 200 to be searched and altered may be incoming media, such as that transmitted from a website, or received from an audio message or text. The incoming media content is received and searched for objectionable data, which is then altered. Searching incoming media content may be useful for a parent who does not want their child exposed to objectionable media content.

Furthermore, the media content to be filtered and altered may be outgoing media, such as that being transmitted through any of the various transmission means discussed above. Similar to the incoming media content, the outgoing media content is received and searched for objectionable data, which is then altered. Searching outgoing media content may be a useful feature for a company that does not want objectionable material to be transmitted from their hardware or social media sites.

A Step 108 comprises transmitting the retrieved media content to a proxy. In some embodiments, all of the incoming and outgoing media content is transmitted to the proxy for review, searching, filtering, and altering. The proxy may be associated with the software, method, system, or workforce of the downloaded software application. In one non-limiting embodiment, the proxy is a third party scanning service. The transmitted media content may be transmitted to a server or a cloud under control of the proxy.

An additional Step 110 may include systematically searching the media content with at least one of the following: an object recognition software, a text recognition software, an audio recognition software, and a voice recognition software. While under control of the proxy, the data in the transmitted media content is searched, through scanning means, for objectionable data. The data to be searched may include, without limitation, image data, video data, pattern data, color data, text data, symbol data, audio data, and voice data.

In some embodiments, any one of various recognition software known in the art may be used to search the data. This may include, without limitation, an object recognition software, a text recognition software, an optical character recognition software, an audio recognition software, and a voice recognition software.

The recognition software utilizes various processes known in the art to identify, and eventually alter the data. In some embodiments, the recognition software may utilize at least one of: machine learning, artificial intelligence, pattern recognition, computational statistics, mathematical optimization, and data mining. The recognition software may also be pre-trained to recognize specific objects, words, sounds, and anatomical motions. The recognition software may also train or learn while being used, so as to further refine the recognition of objectionable data.

One exemplary object recognition software is based on computer vision and image processing that deals with detecting instances of semantic objects of a certain class (such as humans, buildings, or cars) in digital images and videos. One exemplary text recognition software is based on the mechanical or electronic conversion of images of typed, handwritten, or printed text into machine-encoded text, whether from a scanned document, a photo of a document, a scene-photo. One exemplary speech recognition software is based on Hidden Markov Models, which are statistical models that output a sequence of symbols or quantities. In all cases, the image data, video data, pattern data, color data, text data, symbol data, audio data, and voice data are systematically searched and analyzed by the appropriate recognition software.

A Step 112 comprises identifying, by the recognition software, an objectionable portion of the data. In some embodiments, the objectionable portion of the data may include, without limitation, pornography, violent images, profane text, profane language, hate speech, propaganda. The recognition software comprises an algorithm that has been programmed or trained to identify a type of objectionable data. Further, the recognition software may be trained through machine learning and artificial intelligence to recognize and refine the identification of the objectionable data.

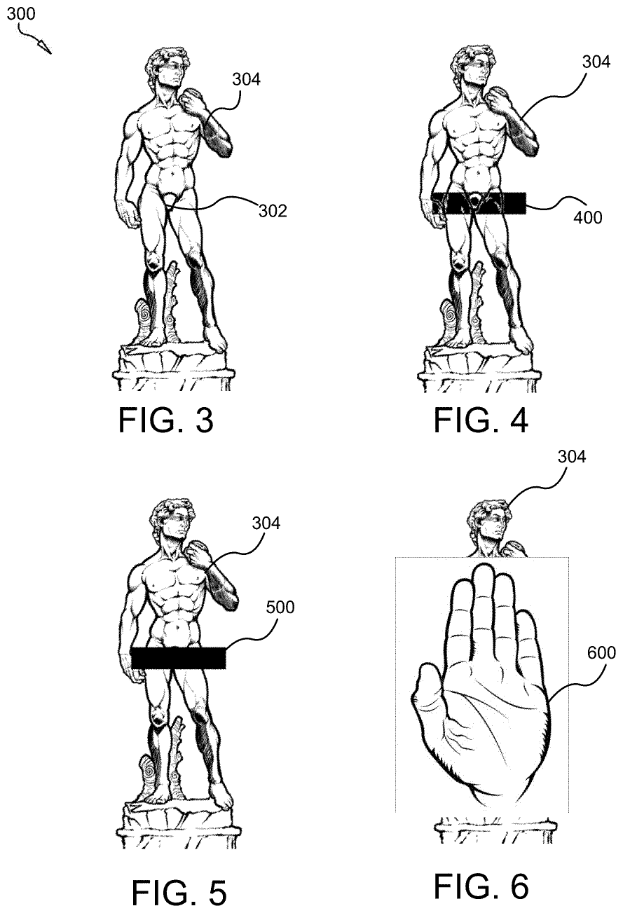

For example, as shown in FIG. 3, the object recognition software may search through a media content 300 and identify an image of elongated shape located midsection of a human (a penis); and thereby mark the elongated shape as objectionable data 302. The upper and lower torso of the statue are identified by the object recognition software as non-objectionable data 304.

In another example, the voice recognition software may identify the words “tit” and “f@\hat{ }k” as objectionable data. In yet another example, the video recognition software may identify the motion of a hand reaching for, and maintaining engagement with a groin or breast region as objectionable data. In all of these instances of objectionable data, the recognition software may be trained through machine learning and artificial intelligence to recognize and refine the identification of the objectionable data.

Another Step 114 includes, whereby the objectionable portion of the data is at least partially determined by the selected objectionable parameter filter and the media transmission filter. The identification of the objectionable portion of the data is partially based on the selected objectionable parameter filter and the media transmission filter. The user selects these parameters. However, as discussed above, the recognition software is also partially determinative of identification of the objectionable data.

In some embodiments, a Step 116 may include identifying, by the recognition software, a non-objectionable portion of the data. The method 100 is unique in that the media content is not simply flagged for an objectionable data and the entire media content consequently deleted. Rather, the objectionable portion of the data is identified and altered, as discussed below, while the non-objectionable portion of the data remains the same, viewable by the user. It is significant to note that the majority of data is generally non-objectionable, while only a small portion of data in media content is objectionable. This selective alteration of data in the media content is a useful feature that allows a substantial portion of the media content to be viewed with minimal disturbances.

For example, a paragraph with a single profane word in it is not completely deleted, but rather the single profane word is identified and then altered. In another example, an anatomy text showing depictions of the human body identifies a penis or vagina (objectionable data) for visual obfuscation, while the remainder of the human body (non-objectionable data) is maintained in its original depiction for viewing. This differentiation between objectionable and non-objectionable data is useful for enabling consumption of the greater, non-objectionable data, while removing only the lesser, objectionable portion of data from the media content.

A Step 118 comprises altering the objectionable portion of image or video data by blurring or covering a portion of the image data with at least one visual barrier. After the objectionable data has been identified by the recognition software, the objectionable data is altered, or obfuscated, so that it is no longer apparent in its original form. However, the portion of the media content that is non-objectionable remains the same, unaltered. In the case of image data, at least one visual barrier is used to blur or cover the objectionable data; and in some cases, a proximal area of the objectionable data.

For example, FIG. 4 illustrates a semi-opaque bar visual barrier 400 covering a penis (objectionable data) of a statue, such that the penis is partially visible, but not fully apparent. This may create a blurry visual effect that enables an only partial, obfuscated view of the penis. The semi-opaque bar visual barrier 400 may be useful for viewing media content associated with scholarly or artistic depictions of a human body, where perversion is not the intent; but the image is still considered objectionable by the user.

Looking now at FIG. 5, the visual barrier is in the form of a solid bar visual barrier 500 that completely covers the objectionable penis. The solid bar visual barrier 500 might be useful for protecting children from the full view of a naked human, such as in pornography. Similarly, FIG. 6 illustrates an exaggerated visual barrier 600, showing a drawing of a large hand that covers, not only the penis, but the proximal area around the penis. The exaggerated visual barrier 600 might be useful for covering pornographic material that contains other objectionable images, i.e., an open mouth, in the proximity of the penis.

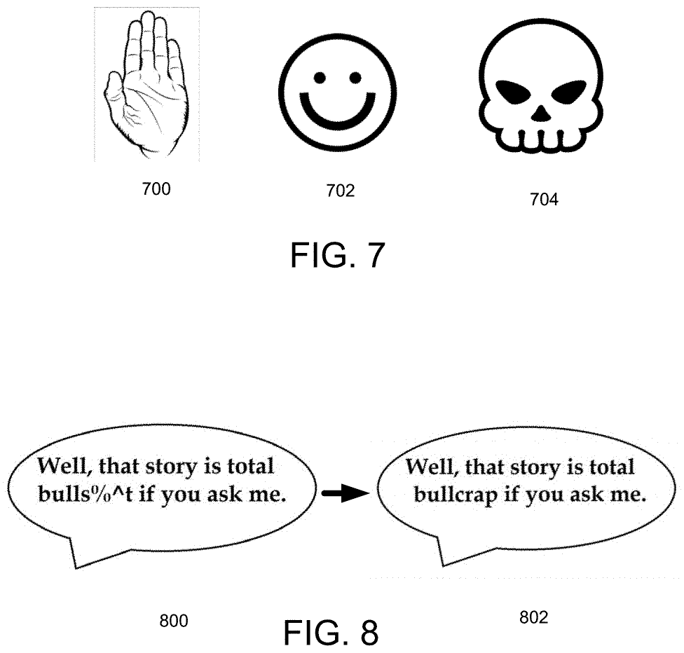

In some embodiments, the method enables the user to select the type and size of visual barrier 400, 500, 600 that blurs, or covers the objectionable image data 302. In this manner, the user can create an ornamental effect, or deliver a message to anyone attempting to view the objectionable image data 302. FIG. 7 illustrates various examples of these types of visual barriers, showing: a hand visual barrier 700, an emoji visual barrier 702, and a skull visual barrier 704. However in other embodiments, the visual barrier 400, 500, 600 includes eclectic types of pictures, words, and symbols that cover the objectionable image data 302.

A Step 120 comprises altering the objectionable portion of video data by terminating operation of a camera. This is a useful function for altering outgoing videos from a webcam. For example, if a user is performing objectionable actions, the video image is identified, and the web camera is powered off. In this manner, the video of the objectionable video data is not viewable. However, this may also be used for terminating viewing of videos from incoming video data. One example is the video recognition software identifies the motion of a hand reaching for, and maintaining engagement with a groin or breast region as objectionable data

A Step 122 comprises altering the objectionable portion of text data by replacing the objectionable text data 208 with a synonym 212. The text recognition software is configured to identify and replace profane words or phrases from a body of text. As discussed above, the method 100 does not delete the objectionable data, but rather alters it. In the case of text data, after the text recognition software identifies the objectionable text data 208, a synonym 212, or similar meaning word is used to replace, or alter the objectionable text.

For example, FIG. 8 references an objectionable phrase 800, “Well, that story is totally bulls % At if you ask me” (objectionable), being replaced with an altered phrase 802, “Well, that story is totally bullcrap if you ask me” (non-objectionable). In another example, a received text may read the word “tit”. This word is replaced with the synonym “mammary gland”. Or the word “ass” in an email may be replaced with the synonym “buttocks”.

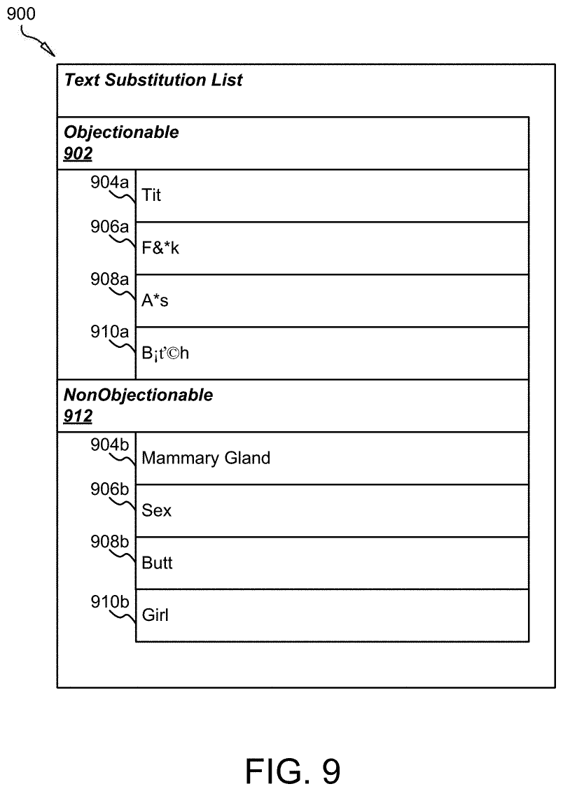

As FIG. 9 references, the text recognition software may also be preprogrammed to include a text substitution table 900. The table 900 contains a list of objectionable text, and corresponding non-objectionable text that correspond to, and replace the objectionable text. The text recognition software draws from the table 900 to alter the objectionable text by matching with an objectionable list of words 902 in the table 900, and replacing the objectionable text with a correlating word from the non-objectionable list of words 912. As shown in the table 900, the word “tit” 904a is replaced with “mammary gland” 904b. The word “F&*k” 906a is replaced with the word “Sex” 906b. The word “Ass” 908a is replaced with the word “Butt” 908b. The word “Bitch” 910a is replaced with the word “Girl” 910b. In one alternative embodiment, the user may edit the non-objectionable list of words 912 to customize the replacement text.

A Step 124 comprises altering the objectionable portion of audio data by deleting or replacing the audio data. This function is useful for replacing or simply deleting profane words or phrases from an audio message or recording. The voice or audio recognition software recognizes a profane word, such as “ass”, and replaces with a synonym 212, such as “buttocks. Or the voice or audio recognition software may simply delete the word “ass”, which also serves to alter the audio data.

In an alternative embodiment of the present invention, a Step further includes identifying and inhibiting the entire media content. The entire media content may include, without limitation, a webpage, entire images, unsolicited messages, black listed websites, pop-up advertisements, suspicious webcam or hacking websites, a pornography or hate website, and screens from an objectionable or inappropriate search. In this embodiment, rather than altering the objectionable data, the recognition software inhibits substantially the entire media content, including both objectionable, and non-objectionable data.

A final Step 126 includes returning the media content with the objectionable portion of the data altered, and the non-objectionable portion of the data uncompromised. The proxy returns the searched and possibly altered media content to the user on the same communication device that the media content was received or sent out from. The media content is substantially in its original form, except that objectionable data is altered, covered, deleted, or otherwise not consumable by the user. The method 100 is unique in that the non-objectionable portion of the data remains unaltered so that the media content remains substantially in its original format. This allows the original media content to be viewed with minimal compromise.

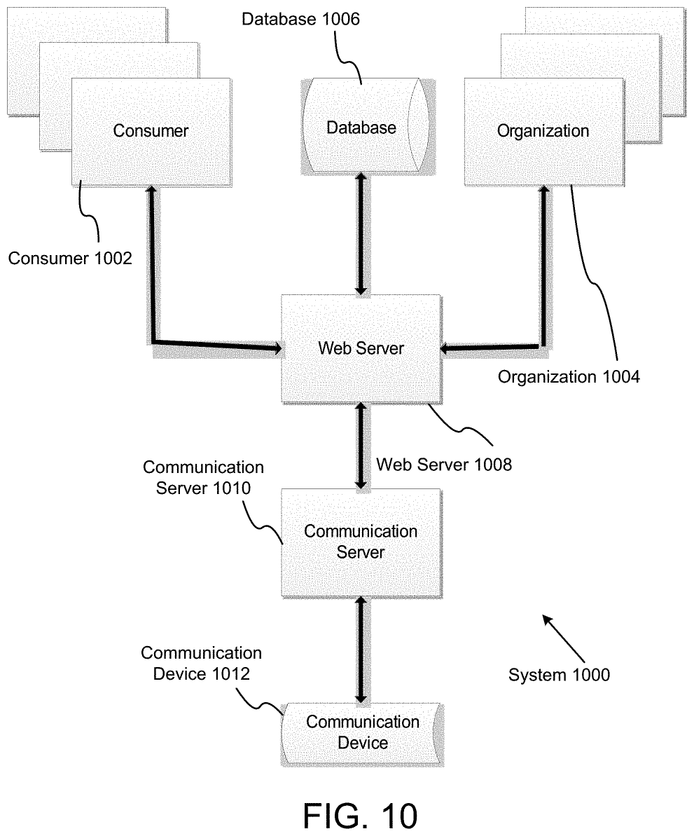

FIG. 10 is a user-proxy diagram illustrating the relationship between an exemplary user and proxy that exchange data and search queries through an exemplary web server, in accordance with an embodiment of the present invention. In the present invention, a system 1000, a user 1002 and a proxy 1004 communicate with a web server 1008. The user 1002 and the proxy 1004 may register with the system 1000. The web server 1008 may store data information in a database 1006. The user 1002 and the proxy 1004 may transfer retrieved data from a search query to the web server 1008. A communication server 1010 may format and store the retrieved data. The communication server 1010 may transfer the retrieved data to a communication device 1012 utilized by the user 1002 and/or the proxy 1004.

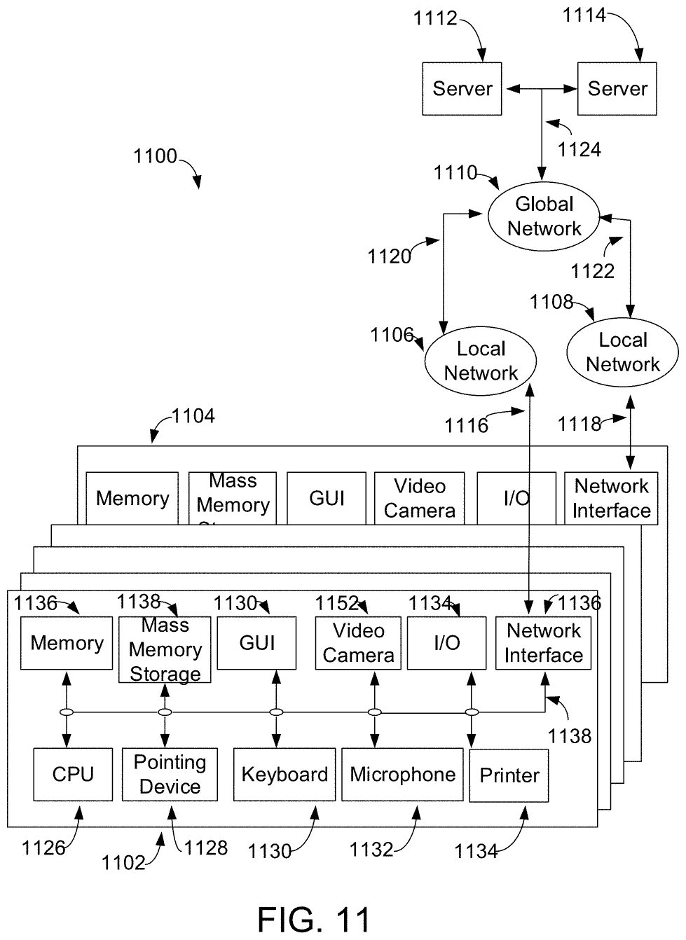

FIG. 11 is a typical computer system that, when appropriately configured or designed, can serve as an exemplary method for identification, in accordance with an embodiment of the present invention. In the present invention, a communication system 1100 includes a multiplicity of clients with a sampling of clients denoted as a client 1102 and a client 1104, a multiplicity of local networks with a sampling of networks denoted as a local network 1106 and a local network 1108, a global network 1110 and a multiplicity of servers with a sampling of servers denoted as a server 1112 and a server 1114.

Client 1102 may communicate bi-directionally with local network 1106 via a communication channel 1116. Client 1104 may communicate bi-directionally with local network 1108 via a communication channel 1118. Local network 1106 may communicate bi-directionally with global network 1110 via a communication channel 1120. Local network 1108 may communicate bi-directionally with global network 1110 via a communication channel 1122. Global network 1110 may communicate bi-directionally with server 1112 and server 1114 via a communication channel 1124. Server 1112 and server 1114 may communicate bi-directionally with each other via communication channel 1124. Furthermore, clients 1102, 1104, local networks 1106, 1108, global network 1110 and servers 1112, 1114 may each communicate bi-directionally with each other.

In one embodiment, global network 1110 may operate as the Internet. It will be understood by those skilled in the art that communication system 1100 may take many different forms. Non-limiting examples of forms for communication system 1100 include local area networks (LANs), wide area networks (WANs), wired telephone networks, wireless networks, or any other network supporting data communication between respective entities.

Clients 1102 and 1104 may take many different forms. Non-limiting examples of clients 1102 and 1104 include personal computers, personal digital assistants (PDAs), cellular phones and smartphones.

Client 1102 includes a CPU 1126, a pointing device 1128, a keyboard 1130, a microphone 1132, a printer 1134, a memory 1136, a mass memory storage 1138, a GUI 1140, a video camera 1142, an input/output interface 1144 and a network interface 1146.

CPU 1126, pointing device 1128, keyboard 1130, microphone 1132, printer 1134, memory 1136, mass memory storage 1138, GUI 1140, video camera 1142, input/output interface 1144 and network interface 1146 may communicate in a unidirectional manner or a bi-directional manner with each other via a communication channel 1148. Communication channel 1148 may be configured as a single communication channel or a multiplicity of communication channels.

CPU 1126 may be comprised of a single processor or multiple processors. CPU 1126 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 1136 is used typically to transfer data and instructions to CPU 1126 in a bi-directional manner. Memory 1136, as discussed previously, may include any suitable computer-readable media, intended for data storage, such as those described above excluding any wired or wireless transmissions unless specifically noted. Mass memory storage 1138 may also be coupled bi-directionally to CPU 1126 and provides additional data storage capacity and may include any of the computer-readable media described above. Mass memory storage 1138 may be used to store programs, data and the like and is typically a secondary storage medium such as a hard disk. It will be appreciated that the information retained within mass memory storage 1138, may, in appropriate cases, be incorporated in standard fashion as part of memory 1136 as virtual memory.

CPU 1126 may be coupled to GUI 1140. GUI 1140 enables a user to view the operation of computer operating system and software. CPU 1126 may be coupled to pointing device 1128. Non-limiting examples of pointing device 1128 include computer mouse, trackball and touchpad. Pointing device 1128 enables a user with the capability to maneuver a computer cursor about the viewing area of GUI 1140 and select areas or features in the viewing area of GUI 1140. CPU 1126 may be coupled to keyboard 1130. Keyboard 1130 enables a user with the capability to input alphanumeric textual information to CPU 1126. CPU 1126 may be coupled to microphone 1132. Microphone 1132 enables audio produced by a user to be recorded, processed and communicated by CPU 1126. CPU 1126 may be connected to printer 1134. Printer 1134 enables a user with the capability to print information to a sheet of paper. CPU 1126 may be connected to video camera 1142. Video camera 1142 enables video produced or captured by user to be recorded, processed and communicated by CPU 1126.

CPU 1126 may also be coupled to input/output interface 1144 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1126 optionally may be coupled to network interface 1146 which enables communication with an external device such as a database or a computer or telecommunications or internet network using an external connection shown generally as communication channel 1116, which may be implemented as a hardwired or wireless communications link using suitable conventional technologies. With such a connection, CPU 1126 might receive information from the network, or might output information to a network in the course of performing the method steps described in the teachings of the present invention.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for identifying and altering objectionable media, the steps of the method comprising:
retrieving incoming and outgoing media content;
transmitting the retrieved media content to a proxy;
systematically searching the media content with a recognition software;
identifying, by the recognition software, an objectionable portion of the data;
identifying, by the recognition software, a non-objectionable portion of the data;
altering the objectionable portion of the data; and
returning the media content with the objectionable portion of the data altered, and the non-objectionable portion of the data uncompromised.

2. The method of claim 1, further comprising selecting at least one objectionable parameter filter and at least one media transmission filter.

3. The method of claim 2, wherein the objectionable portion of the data is at least partially determined by the selected objectionable parameter filter and the media transmission filter.

4. The method of claim 3, further comprising identifying the objectionable portion of the data, based at least partially on the objectionable parameter filter and the media transmission filter.

5. The method of claim 4, wherein the objectionable parameter filter includes at least one of the following: images, text, video, language, and audio.

6. The method of claim 5, wherein the media transmission filter includes at least one of the following: email, text message, voicemail, phone, and camera.

7. The method of claim 1, wherein the proxy is a third party scanning service.

8. The method of claim 1, wherein the data includes at least one of the following: image data, video data, pattern data, color data, text data, symbol data, audio data, and voice data.

9. The method of claim 1, wherein the recognition software includes at least one of the following: an object recognition software, a text recognition software, an optical character recognition software, an audio recognition software, and a voice recognition software.

10. The method of claim 1, wherein the objectionable portion of the data includes at least one of the following: pornography, violent images, profane text, profane language, hate speech, propaganda.

11. The method of claim 1, further comprising altering the objectionable portion of the image data by blurring or covering a portion of the image data with at least one visual barrier.

12. The method of claim 1, further comprising altering the objectionable portion of the video data by terminating operation of a camera.

13. The method of claim 1, further comprising altering the objectionable portion of the text data by replacing the objectionable text data with a synonym.

14. The method of claim 1, further comprising altering the objectionable portion of the audio data by deleting or replacing the audio data.

15. The method of claim 1, further comprising identifying and inhibiting an entire media content from at least one of the following: entire images, unsolicited messages, black listed websites, pop-up advertisements, and webcam websites.

16. The method of claim 1, further comprising downloading the computer-implemented method on a communication device.

17. A computer program product comprising a signal bearing computer-readable medium having computer-usable program code executable for identifying and altering objectionable media, the operations of the computer program product comprising:
selecting at least one objectionable parameter filter and at least one media transmission filter;
retrieving incoming and outgoing media content;
transmitting the retrieved media content to a proxy;
systematically searching the media content with a recognition software, the data including at least one of the following: image data, video data, pattern data, color data, text data, symbol data, audio data, and voice data;
identifying, by the recognition software, an objectionable portion of the data;
whereby the objectionable portion of the data is at least partially determined by the selected objectionable parameter filter and the media transmission filter;
identifying, by the recognition software, a non-objectionable portion of the data;
altering the objectionable portion of the image data by blurring or covering a portion of the image data with at least one visual barrier;
altering the objectionable portion of the text data by replacing the objectionable text data with a synonym;
altering the objectionable portion of the audio data by deleting or replacing the audio data; and
returning the media content with the objectionable portion of the data altered, and the non-objectionable portion of the data uncompromised.

18. The method of claim 17, wherein the media transmission filter includes at least one of the following: email, text message, voicemail, phone, and camera.

19. The method of claim 17, wherein the recognition software includes at least one of the following: an object recognition software, a text recognition software, an optical character recognition software, an audio recognition software, and a voice recognition software.

20. A system for identifying and altering objectionable media, the system comprising:
a downloader module on a communication device configured to download media to memory;
a selecter module configured to select at least one objectionable parameter filter and at least one media transmission filter;
a retriever module configured to retrieve incoming and outgoing media content;
a transmitter module configured to transmit the retrieved media content to a third party scanning service;
a search module configured to systematically search the media content with a recognition software;
wherein the data comprises at least one of the following: image data, video data, pattern data, color data, text data, symbol data, audio data, and voice data;
wherein recognition software comprises at least one of the following: an object recognition software, a text recognition software, an optical character recognition software, an audio recognition software, and a voice recognition software;
an identification module configured to identify an objectionable portion of the data, the objectionable portion of the data including at least one of the following: pornography, violent images, profane text, profane language, hate speech, propaganda;
whereby the objectionable portion of the data is at least partially determined by the selected objectionable parameter filter and the media transmission filter;
an identifier module configured to identify a non-objectionable portion of the data;
a first alterer module configured to alter the objectionable portion of image data by blurring or covering a portion of the image data with at least one visual barrier;
a second alterer module configured to alter the objectionable portion of video data by terminating operation of a camera;
a third alterer module conjured to alter the objectionable portion of text data by replacing the objectionable text data with a synonym;
a fourth alterer module configured to alter the objectionable portion of audio data by deleting or replacing the audio data; and
a returner module configured to return the media content with the objectionable portion of the data altered and the non-objectionable portion of the data uncompromised.
